(19) United States
(12) Patent Application Publication
(10) Pub. No.: US 2008/0009260 A1
(43) Pub. Date: Jan. 10, 2008

(54) MIXER WITH DYNAMIC INTERMEDIATE FREQUENCY FOR RADIO-FREQUENCY FRONT-END AND METHOD USING THE SAME

(75) Inventor: Chinq-shiun Chiu, Hsinchu City (TW)

Correspondence Address: MADSON & AUSTIN, 15 WEST SOUTH TEMPLE, SUITE 900, SALT LAKE CITY, UT, 84101, US

(73) Assignee: MediaTek Inc., Hsin-Chu City (TW)

(21) Appl. No.: 11/456,508

(22) Filed: Jul. 10, 2006

(51) Int. Cl. H04B 1/26

(52) U.S. Cl. 455/323

(57) ABSTRACT

A mixer with dynamic intermediate frequency in a RF front-end to dynamically adjust the intermediate frequency and method thereof are described. The radio-frequency front-end comprises a band-pass filter, an amplifier, a first mixer unit and a second mixer unit. The band-pass filter receives first RF signal to generate second RF signal. The amplifier amplified the second RF signal and output third RF signal (S_{RF}). The first mixer unit is used to mix the third RF signal (S_{RF}) with first frequency signal (S₁) to down convert the third RF signal (S_{RF}) to an intermediate frequency (IF) and outputs an IF signal (S_{IF}). The second mixer unit is connected to the first mixer unit in a cascode configuration and has I-channel and Q-channel mixers to transform IF signal (S_{IF}) to an I-channel signal (S_{I}) and a Q-channel signal (S_{Q}). The radio-frequency front-end further comprises a dividing unit for receiving an oscillator signal (S₀) to generate the first, the second and the third frequency signals (S₁, S₂, and S₃) such that the frequency of the first frequency signal (S₁) substantially equals the frequency of the oscillator signal (S₀) divided by two's power of a first non-negative integer (N₁), the frequency of the second and the third frequency signals (S₂, and S₃) substantially both equals the frequency of the oscillator signal (S₀) divided by two's power of a second non-negative integer (N₂), and the second frequency signal (S₂) is approximately 90 degree out of phase with respect to the third frequency signal (S₃).

### FIELD OF THE INVENTION

The present invention generally relates to a communication system and method, and more particularly, to a mixer with dynamic intermediate frequency (IF) used in a radio-frequency (RF) front-end of direct conversion transceiver to dynamically adjust the intermediate frequency and method thereof.

### BACKGROUND OF THE INVENTION

Currently, there is a great amount of activity to realize low cost transceivers for the wireless communication applications. Examples of communication applications include digital cordless telephones, digital cellular, wireless modems, and wireless personal communication networks. All transceiver architectures routinely employ a mixer in the frequency translation of the most transceivers from the radio frequency to the intermediate frequency (IF) and vice versa.

A kind of receiver topology is called a direct conversion receiver which directly down converts the RF signals into baseband signals. The direct conversion receiver has a much easier layout, and cost effective than using expensive IF filters. Therefore, the direct conversion topology is much less expensive to build than the conventional receiver with IF electronics. However, improper isolation between local oscillator (LO) and RF signals is induced, thereby producing a self-mixing phenomenon, as shown in FIG. 1.

There is a self-mixing 100 problem between the local oscillator (LO) source 102 and radio-frequency (RF) signals 104 in a conventional harmonic mixer. The variable direct-current (DC) IF signals 106 is generated by the mixture of the LO signal and radio-frequency (RF) signal 104 in a mixer 108. However, before entering the mixer 108, the RF signal 104 has been mixed with the LO signal and thus may saturates the baseband amplifiers 110, thereby limiting the receiver sensitivity.

In addition, a conventional implementation of RF front-end with coupling capacitors and inductor-based loads which are opposed to resistor-based loads, in combination with mixer LO frequencies 200, is proposed in FIG. 2. An embodiment of this technology is discussed in U.S. Pat. No. 6,351,502, entitled to “RF Front-end with Multistage Stepdown Filtering Architecture”. However, a first mixer 202, second mixer 204 and local noise amplifier (LNA) 206 are inductor-based loads, resulting in a large amount area occupation on the RF front-end circuitry.

Further, a multistage stepdown filtering architecture is employed so that additional coupling capacitor 210 between the LNA 206 and first and second mixers (202, 204) are required. This approach also has much more power consumption due to the additional components. In other words, this RF front-end utilizes a complicated architecture, i.e. multistage stepdown mechanism, to down convert RF signals to form signals (S_{I} and S_{Q}) by a divider 208 of mixer LO frequencies 200.

Consequently, there is a need to develop a simplified mixer architecture having first and second mixers in order to improve the complicated mixer architecture and solve the problems of self-mixing of the RF front-end in communication system.

### SUMMARY OF THE INVENTION

One object of the present invention is to provide a mixer apparatus having first and second mixer units in a cascode configuration to dynamically adjust the intermediate frequency (IF) used in a radio-frequency front-end.

Another object of the present invention is to provide a mixer apparatus with a dividing unit to provide a plurality of frequency signals to the first and the second mixer units to improve the efficiency of the radio-frequency front-end.

Still one object of the present invention is to provide a radio-frequency front-end with simplified mixer architecture to reduce the size of the circuitry and for low voltage and power consumption.

According to the above objects, the present invention sets forth a radio-frequency front-end with single-stage mixer units having dynamic intermediate frequency (IF) and method thereof. The radio-frequency front-end comprises a band-pass filter, an amplifier, a first mixer unit and a second mixer unit. The band-pass filter receives a first radio frequency (RF) signal to suppress the unwanted signal that is out of the wanted frequency band to generate a second RF signal. The amplifier is connected to the band-pass filter to amplify the second RF signal and output a third RF signal, denoted by S_{RF}. The first mixer unit coupled to the amplifier is used to mix the third RF signal (S_{RF}) with a first frequency signal (S₁) to down convert the third RF signal (S_{RF}) to an intermediate frequency (IF) and outputs an IF signal, denoted by S_{IF}. The second mixer unit is connected to the first mixer unit in a cascode configuration and has an I-channel mixer and a Q-channel mixer to transform IF signal (S_{IF}) to an I-channel signal (S_{I}) and a Q-channel signal (S_{Q}). Note that the single-stage structure with cascode configuration can improve circuit noise. Further, some kind of active or passive components, such as coupling capacitors, between the first and the second mixer units in the single-stage structure are removed to reduce the size of the first and the second mixer units within the radio-frequency front-end circuitry. Moreover, such a cascode configuration benefits lower power consumption on the radio-frequency front-end.

The I-channel mixer is used to mix the IF signal (S_{IF}) with a second frequency signal (S₂) to output the I-channel signal (S_{I}) at baseband. The Q-channel mixer is used to mix IF signal (S_{IF}) with a third frequency signal (S₃) to output the Q-channel signal (S_{Q}) at baseband. Note that, in order to improve the noise immunity, the third RF signal (S_{RF}), the first frequency signal (S₁), the second frequency signal (S₂), and the third frequency signal are preferably of differential type. However, the present invention is also applicable to the case that the signals are of single-ended type.

The radio-frequency front-end further comprises a dividing unit connected to the first and the second mixer units for receiving an oscillator signal (S₀) to generate the first frequency signal (S₁), the second frequency signal (S₂), and the third frequency signal (S₃) such that the frequency of the first frequency signal (S₁) substantially equals the frequency of the oscillator signal (S₀) divided by two's power of a first non-negative integer (N₁), the frequency of the second and the third frequency signal (S₂, S₃) substantially both equals the frequency of the oscillator signal (S₀) divided by two's power of a second non-negative integer (N₂), and the second frequency signal (S₂) is approximately 90 degree out of phase with respect to the third frequency signal (S₃). In order to down convert the third RF signal (S_{RF}) to the baseband, the frequency summation of the first and second (or third) frequency signals (S₂ or S₃) is substantially and preferably exactly equal to the frequency of the third RF signal (S_{RF}). It should be noted that although the carrier frequency of the third RF signal (S_{RF}) is preferably exactly equal to the frequency summation of the signals (S₁ and S₂), the frequency of the third RF signal (S_{RF}) may not exactly equal, but substantially equal, the frequency summation of the signals (S₁ and S₂) due to practical limitation of the physical circuit.

When down converting a radio-frequency signal with a single-stage mixer according to the present invention, a first radio frequency (RF) signal is filtered by a band-pass filter to generate a second RF signal. Then, the second RF signal is amplified and outputs a third RF signal. Thereafter, an oscillator signal is divided to generate a first, a second, and a third frequency signals. The frequency of the first frequency signal substantially equals the frequency of the oscillator signal divided by two's power of a first non-negative integer. The frequency of the second and the third frequency signals substantially equals the frequency of the oscillator signal divided by two's power of a second non-negative integer. The second frequency signal is approximately 90 degree out of phase with respect to the third frequency signal.

Next, the radio frequency signal at a carrier frequency is mixed with the first frequency signal to down convert the RF signal to an intermediate frequency (IF) and output an IF signal using a first mixer. The frequency of the first frequency signal is preferably smaller than an oscillator signal inputted into the dividing unit to eliminate phase noise of the amplified received signal. Finally, the IF signal is mixed with the second and the third frequency signals using a second mixer to output an I-channel signal and a Q-channel signal at baseband, respectively, where the first mixer and the second mixers are connected in a cascode configuration with the second mixer.

The advantages of the present invention include: (a) providing mixer architecture in a cascode configuration to dynamically adjust the intermediate frequency in a radio-frequency front-end; (b) providing simplified mixer architecture with a dividing unit to improve the efficiency of the radio-frequency front-end; and (c) reducing the size of the circuitry in the radio-frequency front-end.

### BRIEF DESCRIPTION OF THE DRAWINGS

FIG. 1 is a schematic diagram of a conventional harmonic mixer.

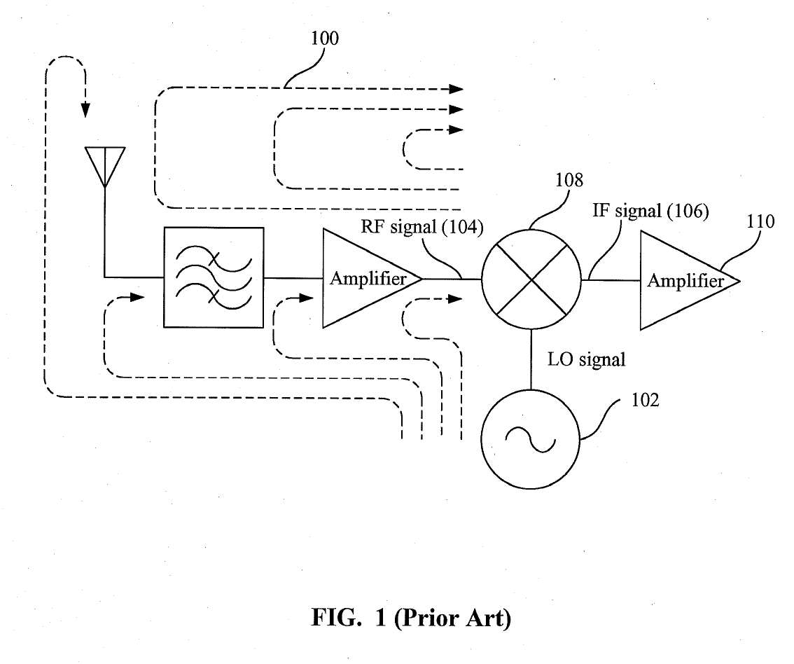

FIG. 2 is a schematic diagram of conventional implementation with coupling capacitors and inductor-based loads in the RF front-end circuitry.

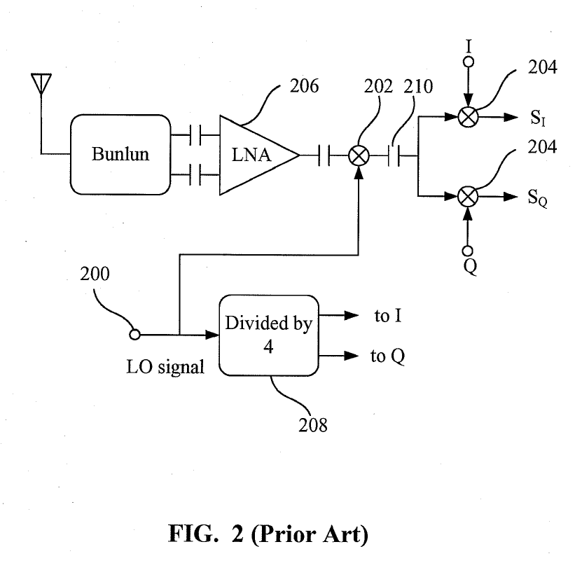

FIG. 3 illustrates a schematic block diagram of a radio-frequency front-end with mixers according to one embodiment of the present invention.

FIGS. 4A and 4B illustrate detailed schematic diagrams of the dividing unit in FIG. 3 according to one embodiments of the present invention.

FIG. 5 illustrates a detailed schematic diagram of the first and the second mixer units in a cascode configuration in FIG. 3 according to one embodiment of the present invention.

FIG. 6 illustrates schematic frequency spectra and corresponding amplitude at different nodes of the mixer units of the cascode configuration in FIG. 5 according to one embodiment of the present invention.

FIG. 7 shows a flow chart of down converting a radio-frequency signal with a single-stage mixer according to the present invention.

### DETAILED DESCRIPTION OF THE PREFERRED EMBODIMENTS

The present invention is directed to the simplified mixer architecture with dynamic intermediate frequency used in a radio-frequency (RF) front-end to actively adjust the intermediate frequency by the first and the second mixer units in a cascode configuration. A dividing unit can be further employed to receive an oscillator signal to provide a first, a second, and a third frequency signals to the first and the second mixer units. Moreover, the radio-frequency front-end with simplified mixer architecture can reduce the size of the circuitry. The mixer architecture of the present invention is applicable to any kind of transceivers including receivers and transmitters, preferably for direct conversion receivers.

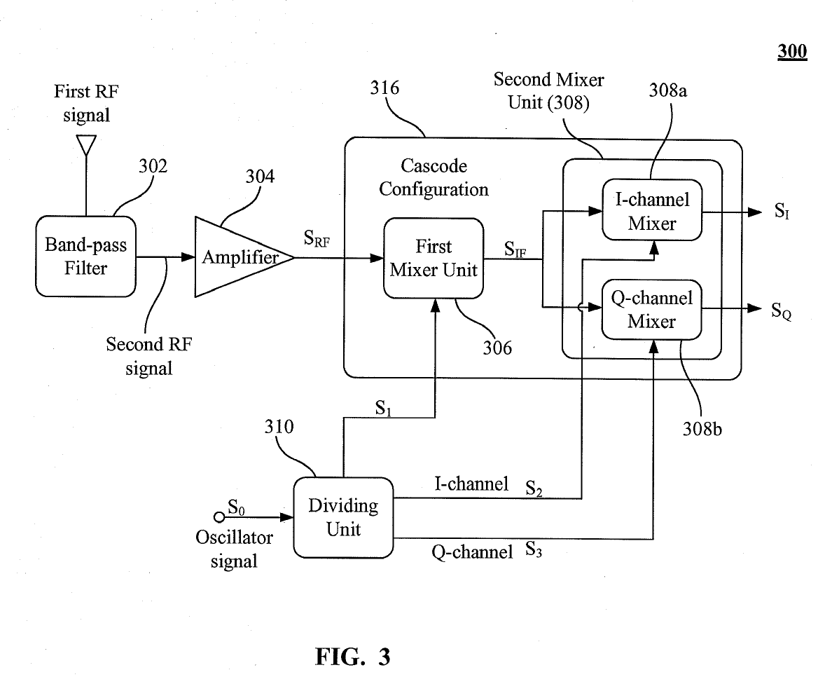

Referring to FIG. 3, a schematic block diagram of a radio-frequency front-end with mixers according to one embodiment of the present invention is shown. The radio-frequency front-end 300 comprises a band-pass filter 302, an amplifier 304, a first mixer unit 306 and a second mixer unit 308. The band-pass filter 302 receives a first radio frequency (RF) signal to suppress the unwanted signal that is out of the wanted frequency band to generate a second RF signal. The amplifier 304 is connected to the band-pass filter 302 to amplify the second RF signal and output a third RF signal, denoted by S_{RF}. The first mixer unit 306 coupled to the amplifier 304 is used to mix the third RF signal (S_{RF}) with a first frequency signal (S₁) to down convert the third RF signal (S_{RF}) to an intermediate frequency (IF) and outputs an IF signal, denoted by S_{IF}. The second mixer unit 308 is connected to the first mixer unit 306 in a cascode configuration 316, which will be shown in detail later, and has an I-channel mixer 308a and a Q-channel mixer 308b to transform IF signal (S_{IF}) to an I-channel signal (S_{I}) and a Q-channel signal (S_{Q}). Note that the single-stage structure with cascode configuration 316 can improve circuit noise. Further, some kind of active or passive components, such as coupling capacitors, between the first and the second mixer units (306, 308) in the single-stage structure are removed to reduce the size of the first and the second mixer units (306, 308) within the radio-frequency front-end circuitry. Moreover, such a cascode configuration 316 benefits lower power consumption on the radio-frequency front-end.

The I-channel mixer 308a is used to mix the IF signal (S_{IF}) with a second frequency signal (S₂) to output the I-channel signal (S_{I}) at baseband. The Q-channel mixer 308b is used to mix IF signal (S_{IF}) with a third frequency signal (S₃) to output the Q-channel signal (S_{Q}) at baseband. Note that, in order to improve the noise immunity, the third RF signal (S_{RF}), the first frequency signal (S₁), the second frequency signal (S₂), and the third frequency signal are preferably of differential type. However, the present invention can also applied to the case that the signals are of single-ended type.

Referring to FIG. 3 again, the radio-frequency front-end 300 further comprises a dividing unit 310 connected to the first and the second mixer units (306, 308) for receiving an oscillator signal (S₀), e.g. generated by a voltage-controlled oscillator (VCO), to generate the first frequency signal (S₁), the second frequency signal (S₂), and the third frequency signal (S₃) such that the frequency of the first frequency signal (S₁) substantially equals the frequency of the oscillator signal (S₀) divided by two's power of a first non-negative integer (N₁), the frequency of the second and the third frequency signals (S₂, and S₃) substantially both equals the frequency of the oscillator signal (S₀) divided by two's power of a second non-negative integer (N₂), and the second frequency signal (S₂) is approximately 90 degree out of phase with respect to the third frequency signal (S₃). In order to down convert the third RF signal (S_{RF}) to the baseband, the frequency summation of the first and second (or third) frequency signals (S₂ or S₃) is substantially and preferably exactly equal to the frequency of the third RF signal (S_{RF}). It should be noted that although the carrier frequency of the third RF signal (S_{RF}) is preferably exactly equal to the frequency summation of the signals (S₁ and S₂), the frequency of the third RF signal (S_{RF}) may not exactly equal, but substantially equal, the frequency summation of the signals (S₁ and S₂) due to practical limitation of the physical circuit.

In one embodiment, the first non-negative integer (N₁) is 1, the second non-negative integer (N₂) is 2, and the frequency of the oscillator signal (S₀) substantially equals 4/3 times the carrier frequency of the third RF signal (S_{RF}). In other words, we have:

$${f}_{1} = \frac{{f}_{0}}{{2}^{{N}_{1}}} = \frac{{f}_{0}}{2}$$

$${f}_{2} = \frac{{f}_{0}}{{2}^{{N}_{2}}} = \frac{{f}_{0}}{4}$$

$${f}_{RF} = {f}_{1} + {f}_{2} = \frac{3 {f}_{0}}{4}$$

where f₀ is the frequency of the oscillator signal (S₀), f₁ is the frequency of the first frequency signal (S₁), f₂ is the frequency of the first frequency signal (S₂), and f_{RF} is the carrier frequency of the third RF signal (S_{RF}).

Alternatively, the first non-negative integer (N₁) can also be 2, the second non-negative integer (N₂) is 3, and the frequency of the oscillator signal (S₀) substantially equals 8/3 times the carrier frequency of the third RF signal (S_{RF}). In other words, we have:

$${f}_{1} = \frac{{f}_{0}}{{2}^{{N}_{1}}} = \frac{{f}_{0}}{4}$$

$${f}_{2} = \frac{{f}_{0}}{{2}^{{N}_{2}}} = \frac{{f}_{0}}{8}$$

$${f}_{RF} = {f}_{1} + {f}_{2} = \frac{3 {f}_{0}}{8}$$

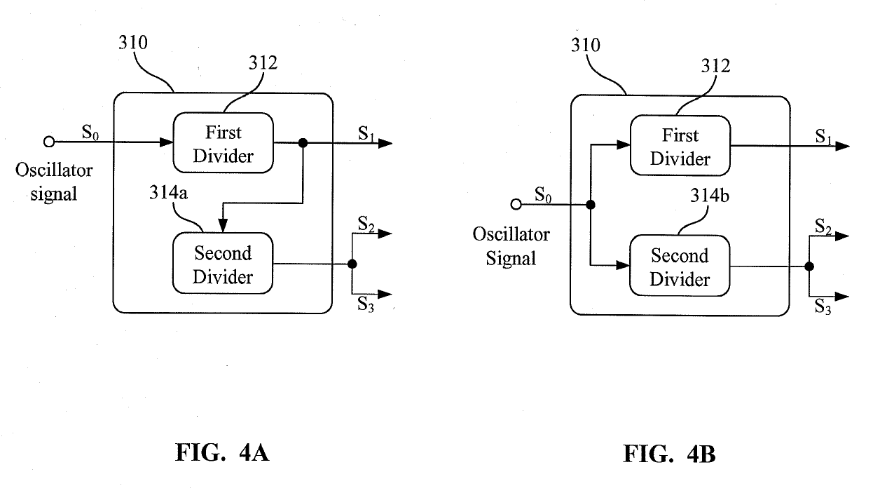

FIGS. 4A and 4B show detailed schematic diagrams of the dividing unit in FIG. 3 according to embodiments of the present invention. In FIG. 4A, the dividing unit 310 includes a first divider 312 and a second divider 314a. The first divider 312 is used to divide the oscillator signal (S₀) to generate the first frequency signal (S₁). The second divider 314a connected to the first divider 312 to further divide the first frequency signal (S₁) to generate the second frequency signal (S₂) and the third frequency signal (S₃). In FIG. 4B, a first divider 312 is used to divide the oscillator signal (S₀) to generate the first frequency signal (S₁) and, on the other hand, a second divider 314b is employed for dividing the oscillator signal (S₀) to generate the second frequency signal (S₂) as well as the third frequency signal (S₃).

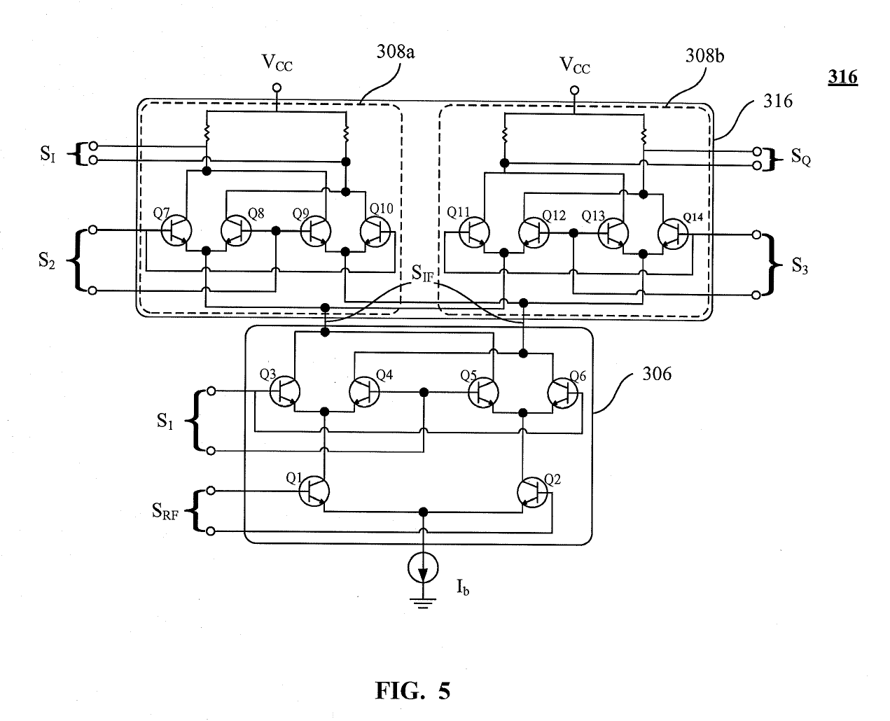

FIG. 5 shows a detailed schematic diagram of the first and the second mixer units in a cascode configuration in FIG. 3 according to one embodiment of the present invention. The first mixer unit 306 includes transistors Q1 to Q6. A RF segment includes transistors Q1 and Q2. The bases of Q1 and Q2 are together used to receive the third RF signal (S_{RF}) that is a differential type signal and the emitters of Q1 and Q2 are connected to a biasing current source (I_{b}). The emitters of Q3, Q4, Q5 and Q6 are coupled to the collectors of Q1 and Q2, respectively. The bases of Q3, Q4, Q5 and Q6 are used to receive the first frequency signal (S₁).

The second mixer unit 308 includes an I-channel mixer 308a and a Q-channel mixer 308b, where the I-channel mixer 308a comprises Q7, Q8, Q9 and Q10, and the Q-channel mixer 308b comprises Q11, Q12, Q13 and Q14. The emitters of Q7 and Q8 in the I-channel mixer 308a as well as the emitters of Q11 and Q12 in the Q channel mixer 308b are connected to the collectors of Q3 and Q5 in the first mixer unit 306. On the other hand, the emitters of Q9 and Q10 in the I-channel mixer 308a as well as the emitters of Q13 and Q14 in the Q-channel mixer 308b are connected to the collectors of Q4 and Q6 in the first mixer unit 306. The bases of Q7, Q8, Q9 and Q10 in the I-channel mixer 308a are used to receive the second frequency signal (S₂), while the bases of the Q11, Q12, Q13 and Q14 in the Q-channel mixer 308b are used to receive the third frequency signal (S₃).

The collectors of Q7 and Q9 are together connected to a load, e.g. resistive component connected to a voltage source (V_{CC}), and so are the collectors of Q8 and Q10, and thus outputs the differential I-channel signal (S_{I}) based on the collectors in the I-channel mixer 308a. Similarly, the collectors of Q11 and Q13 are together connected to a load, e.g. resistive component connected to the voltage source (V_{CC}), and so are the collectors of Q12 and Q14, and thus outputs the differential Q-channel signal (S_{Q}) based on the collectors in the Q channel mixer 308b.

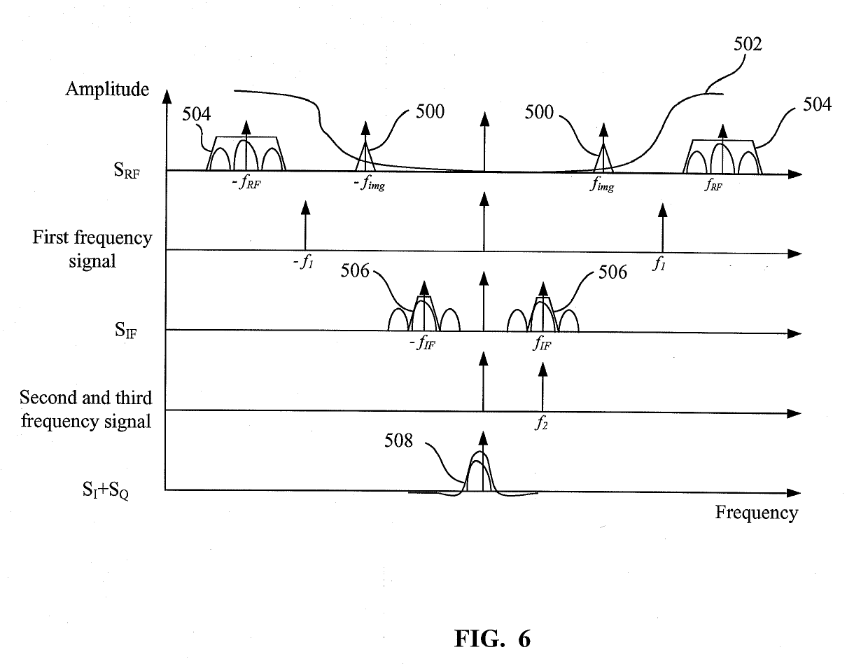

FIG. 6 illustrates schematic frequency spectra and corresponding amplitude at different nodes of the mixer units of the cascode configuration 316 in FIG. 5 according to one embodiment of the present invention. In one embodiment, the first RF signal is suppressed by the band-pass filter 302, such as a surface acoustic wave (SAW) filter generating a suppressed signal 502, to reject unwanted signal, e.g. image signals 500 at the frequencies (f_{img} and −f_{img}) on the opposite side at the carrier frequencies (f_{RF} and −f_{RF}), and thus output the third RF signal (S_{RF}) 504. Then, the third RF signal (S_{RF}) is inputted to the first mixer unit 306. The third RF signal (S_{RF}) is convoluted with the frequencies (f₁ and −f₁) of the first frequency signal (S₁) in the first mixer unit 306 to dynamically generate IF signal (S_{IF}) 506 at the intermediate frequencies (f_{IF} and −f_{IF}). Finally, IF signal (S_{IF}) is convoluted with the frequency (f₂) of the second and the third frequency signals (S₂ and S₃) in the second mixer unit 308, which is optionally filtered by a channel filter (not shown), to form I-channel and Q-channel signals (S_{I} and S_{Q}) 508 at baseband.

The spectra of the first, the second, and the third frequency signals (S₁, S₂ and S₃) generated by a dividing unit 310 in FIG. 3 also are shown in FIG. 6. As above-mentioned, the frequency (f₁) of the first frequency signal (S₁) is equal to the frequency (f₀) of the oscillator signal divided by two's power of x, where x is a non-negative integer. The frequency (f₂) of the second and the third frequency signals (S₂ and S₃) substantially equals the frequency (f₀) of the oscillator signal divided by two's power of a second non-negative integer, and the second frequency signal (S₂) is approximately 90 degree out of phase with respect to the third frequency signal (S₃). The frequency (f₁) of the first frequency signal (S₁) is smaller than the frequency (f₀) of the oscillator signal received by the dividing unit 310 for eliminating phase noise of the second RF signal (S₂) to improve phase noise performance at the carrier frequency (f_{RF}).

As a result, the second mixer unit 308 is sequentially coupled with the first mixer unit 306 in a cascode configuration 316 to construct the single-stage architecture. Namely, the first mixer unit 306 is directly stacked with the second mixer unit 308. The single-stage structure with cascode configuration 316 can improve circuit noise and current or voltage fluctuation in the mixers, and has a reasonably higher gain than that of the multi-stage structure in the prior art.

In the present invention, the frequency (f₀) is suitable for any frequency or frequency bands, such as Industrial scientific Medical (ISM, frequency band), Global System for Mobile Communication (GSM), Advance Mobile Phone System (AMPS), and Digital Communication System (DCS). In one embodiment, the frequency (f₀) is no greater than 5.0 GHz. Preferably, the frequency (f₀) is no greater than 2.4 GHz. More preferably, the frequency (f₀) has a frequency ranging from 0.8 to 2.4 GHz.

In one preferred embodiment, the size of the radio-frequency front-end circuitry is significantly reduced because the load of the LNA 302 and the second mixer unit 308 in FIG.3 is resistor-based. Preferably, the size-reduced level of the resistor-based loads is up to 100˜1000 or more times in comparison with conventional inductive loads of the amplifier or mixer to advantageously increase design capability of the radio-frequency front-end.

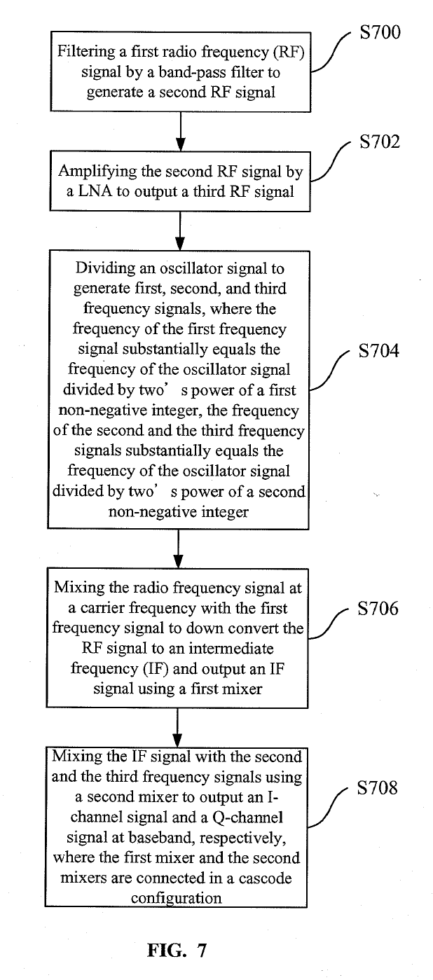

FIG. 7 shows a flow chart of down converting a radio-frequency signal with a single-stage mixer according to the present invention. Starting at step S700, a first radio frequency (RF) signal is filtered by a band-pass filter to generate a second RF signal. Then, in step S702, the second RF signal is amplified by a LNA and outputs a third RF signal.

Thereafter, in step S704, an oscillator signal is divided to generate a first, a second, and a third frequency signals. The frequency of the first frequency signal substantially equals the frequency of the oscillator signal divided by two's power of a first non-negative integer. The frequency of the second and the third frequency signals substantially equals the frequency of the oscillator signal divided by two's power of a second non-negative integer. The second frequency signal is approximately 90 degree out of phase with respect to the third frequency signal.

In one embodiment, during the step of dividing the oscillator signal to generate the first, the second, and the third frequency signals, the oscillator signal is divided to generate the first frequency signal and then the first frequency signal is divided to generate the second frequency signal and the third frequency signal. In another embodiment, during the step of dividing the oscillator signal, the oscillator signal is divided to generate the first frequency signal and the oscillator signal is divided to generate the second frequency signal and the third frequency signal. Next, in step S706, the radio frequency signal at a carrier frequency is mixed with the first frequency signal to down convert the RF signal to an intermediate frequency (IF) and output an IF signal using a first mixer. The frequency of the first frequency signal is preferably smaller than an oscillator signal inputted into the dividing unit to eliminate phase noise of the amplified received signal.

Finally, in step S708, the IF signal is mixed with the second and the third frequency signals using a second mixer to output an I-channel signal and a Q-channel signal at baseband, respectively, where the first mixer and the second mixers are connected in a cascode configuration with the second mixer.

The advantages of the present invention include: (a) providing a mixer architecture having first and second mixer units in a cascode configuration to dynamically adjust the intermediate frequency in a radio-frequency front-end; (b) providing a simplified mixer architecture with a dividing unit to provide a plurality of frequency signals to the first and the second mixer units to improve the efficiency of the radio-frequency front-end; (c) providing a radio-frequency front-end with a simplified mixer architecture to reduce the size of the circuitry; and (d) providing a mixer with dynamic intermediate frequency to solve the problem of self-mixing in a radio-frequency front-end.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A radio-frequency front-end, comprising:
a band-pass filter to receive a first radio frequency (RF) signal and generate a second RF signal;
an amplifying unit coupled to the band-pass filter to amplify the second RF signal and output a third RF signal;
a first mixer unit coupled to the amplifying unit for mixing the third RF signal with a first frequency signal to down convert the third RF signal to an intermediate frequency (IF) and output an IF signal; and
a second mixer unit connected to the first mixer unit in a cascode configuration, comprising:
an I-channel mixer for mixing the IF signal with a second frequency signal to output an I-channel signal at baseband; and
a Q-channel mixer for mixing the IF signal with a third frequency signal to output a Q-channel signal at baseband.

2. The radio-frequency front-end of claim 1, wherein the band-pass filter comprises a surface acoustic wave filter to reject an image signal in the first RF signal.

3. The radio-frequency front-end of claim 1, further comprising a dividing unit connected to the first and the second mixer units for dividing an oscillator signal to generate the first, the second, and the third frequency signals.

4. The radio-frequency front-end of claim 3, wherein the frequency of the first frequency signal substantially equals the frequency of the oscillator signal divided by two's power of a first non-negative integer, the frequency of the second and the third frequency signals substantially equals the frequency of the oscillator signal divided by two's power of a second non-negative integer, and the second frequency signal is approximately 90 degree out of phase with respect to the third frequency signal.

5. The radio-frequency front-end of claim 4, wherein the first non-negative integer is 1, the second non-negative integer is 2, and the frequency of the oscillator signal substantially equals 4/3 times a carrier frequency of the third RF signal.

6. The radio-frequency front-end of claim 4, wherein the first non-negative integer is 2, the second non-negative integer is 3, and the frequency of the oscillator signal substantially equals 8/3 times a carrier frequency of the third RF signal.

7. The radio-frequency front-end of claim 4, wherein the dividing unit comprises:
a first divider for dividing the oscillator signal to generate the first frequency signal; and
a second divider coupled to the first divider, for dividing the first frequency signal to generate the second frequency signal and the third frequency signal.

8. The radio-frequency front-end of claim 4, wherein the dividing unit comprises:
a first divider for dividing the oscillator signal to generate the first frequency signal; and
a second divider for dividing the oscillator signal to generate the second frequency signal and the third frequency signal.

9. The radio-frequency front-end of claim 1, wherein the third RF signal, the first frequency signal, the second frequency signal, the third frequency signal are of differential type.

10. The radio-frequency front-end of claim 1, wherein a load of the second mixer unit is resistor-based.

11. A radio-frequency front-end, comprising:
a band-pass filter to receive a first radio frequency (RF) signal and generate a second RF signal;
a low noise amplifier coupled to the band-pass filter to amplify the second RF signal and output a third RF signal;
a dividing unit for receiving an oscillator signal to generate a first, a second, and a third frequency signals, wherein the frequency of the first frequency signal substantially equals the frequency of the oscillator signal divided by two's power of a first non-negative integer, the frequency of the second and the third frequency signals substantially equals the frequency of the oscillator signal divided by two's power of a second non-negative integer, and the second frequency signal is approximately 90 degree out of phase with respect to the third frequency signal;
a first mixer unit coupled to the low noise amplifier for mixing the third RF signal with the first frequency signal to down convert the third RF signal to an intermediate frequency (IF) and output an IF signal; and
a second mixer unit connected to the first mixer unit in a cascode configuration, comprising:
an I-channel mixer for mixing the IF signal with the second frequency signal to output an I-channel signal at baseband; and
a Q-channel mixer for mixing the IF signal with the third frequency signal to output a Q-channel signal at baseband.

12. The radio-frequency front-end of claim 11, wherein the band-pass filter comprises a surface acoustic wave filter to reject an image signal in the third RF signal.

13. The radio-frequency front-end of claim 11, wherein the load of the low noise amplifier is a resistor.

14. The radio-frequency front-end of claim 11, wherein the first non-negative integer is 1, the second non-negative integer is 2, and the frequency of the oscillator signal substantially equals 4/3 times a carrier frequency of the third RF signal.

15. The radio-frequency front-end of claim 11, wherein the first non-negative integer is 2, the second non-negative integer is 3, and the frequency of the oscillator signal substantially equals 8/3 times a carrier frequency of the third RF signal.

16. The radio-frequency front-end of claim 11, wherein the dividing unit comprises:
a first divider for dividing the oscillator signal to generate the first frequency signal; and
a second divider coupled to the first divider, for dividing the first frequency signal to generate the second frequency signal and the third frequency signal.

17. The radio-frequency front-end of claim 11, wherein the dividing unit comprises:
a first divider for dividing the oscillator signal to generate the first frequency signal; and
a second divider for dividing the oscillator signal to generate the second frequency signal and the third frequency signal.

18. The radio-frequency front-end of claim 11, wherein the third RF signal, the first frequency signal, the second frequency signal, the third frequency signal are of differential type.

19. The radio-frequency front-end of claim 11, wherein a load of the second mixer unit is resistor-based.

20. A mixer apparatus, comprising:
a dividing unit for receiving an oscillator signal to generate a first, a second, and a third frequency signals, wherein the frequency of the first frequency signal substantially equals the frequency of the oscillator signal divided by two's power of a first non-negative integer, the frequency of the second and the third frequency signals substantially equals the frequency of the oscillator signal divided by two's power of a second non-negative integer, and the second frequency signal is approximately 90 degree out of phase with respect to the third frequency signal;
a first mixer unit for mixing a radio frequency (RF) signal at a carrier frequency with the first frequency signal to down convert the RF signal to an intermediate frequency (IF) and output an IF signal; and
a second mixer unit connected to the first mixer unit in a cascode configuration, comprising:
an I-channel mixer for mixing the IF signal with the second frequency signal to output an I-channel signal at baseband; and
a Q-channel mixer for mixing the IF signal with the third frequency signal to output a Q-channel signal at baseband.

21. The mixer apparatus of claim 20, wherein the first non-negative integer is 1, the second non-negative integer is 2, and the frequency of the oscillator signal substantially equals 4/3 times the carrier frequency of the third RF signal.

22. The mixer apparatus of claim 20, wherein the first non-negative integer is 2, the second non-negative integer is 3, and the frequency of the oscillator signal substantially equals 8/3 times the carrier frequency of the third RF signal.

23. The mixer apparatus of claim 20, wherein the dividing unit comprises:
a first divider for dividing the oscillator signal to generate the first frequency signal; and
a second divider coupled to the first divider, for dividing the first frequency signal to generate the second frequency signal and the third frequency signal.

24. The mixer apparatus of claim 20, wherein the dividing unit comprises:
a first divider for dividing the oscillator signal to generate the first frequency signal; and
a second divider for dividing the oscillator signal to generate the second frequency signal and the third frequency signal.

25. The mixer apparatus of claim 20, wherein the third RF signal, the first frequency signal, the second frequency signal, the third frequency signal are of differential type.

26. The mixer apparatus of claim 20, wherein a load of the second mixer unit is resistor-based.

27. A method of down converting a radio-frequency (RF) signal, the method comprising the steps of:
dividing an oscillator signal to generate a first, a second, and a third frequency signals, wherein the frequency of the first frequency signal substantially equals the frequency of the oscillator signal divided by two's power of a first non-negative integer, the frequency of the second and the third frequency signals substantially equals the frequency of the oscillator signal divided by two's power of a second non-negative integer, and the second frequency signal is approximately 90 degree out of phase with respect to the third frequency signal;
mixing the radio frequency signal at a carrier frequency with the first frequency signal to down convert the RF signal to an intermediate frequency (IF) and output an IF signal using a first mixer; and
mixing the IF signal with the second and the third frequency signals using a second mixer to output an I-channel signal and a Q-channel signal at baseband, respectively, wherein the first mixer and the second mixers are connected in a cascode configuration.

28. The method of claim 27, wherein the first non-negative integer is 1, the second non-negative integer is 2, and the frequency of the oscillator signal substantially equals 4/3 times a carrier frequency of the RF signal.

29. The method of claim 27, wherein the first non-negative integer is 2, the second non-negative integer is 3, and the frequency of the oscillator signal substantially equals 8/3 times a carrier frequency of the RF signal.

30. The method of claim 27, during the step of dividing the oscillator signal to generate the first, the second, and the third frequency signals, comprising the steps of:
dividing the oscillator signal to generate the first frequency signal; and
dividing the first frequency signal to generate the second frequency signal and the third frequency signal.

31. The method of claim 27, during the step of dividing the oscillator signal to generate the first, the second, and the third frequency signals, comprising the steps of:
dividing the oscillator signal to generate the first frequency signal; and
dividing the oscillator signal to generate the second frequency signal and the third frequency signal.

32. The method of claim 27, wherein the RF signal, the first frequency signal, the second frequency signal, the third frequency signal are of differential type.
